(19) United States
(12) Patent Application Publication
(10) Pub. No.: US 2013/0046736 A1
(43) Pub. Date: Feb. 21, 2013

(54) RECOVERING METHOD AND DEVICE FOR LINUX USING FAT FILE SYSTEM

(71) Applicants: De-Jun Yu, Shanghai (CN); Ming-Yong Sun, Shanghai (CN)

(72) Inventors: De-Jun Yu, Shanghai (CN); Ming-Yong Sun, Shanghai (CN)

(73) Assignee: MStar Semiconductor, Inc., Hsinchu County (TW)

(21) Appl. No.: 13/555,279

(22) Filed: Jul. 23, 2012

(30) Foreign Application Priority Data
Aug. 16, 2011 (CN) 201110234885.8

(51) Int. Cl. G06F 7/00; G06F 17/30

(52) U.S. Cl. 707/674; 707/E17.01; 707/E17.014

(57) ABSTRACT

A recovery method applied to the FAT file system in a Linux operating system is provided. The method includes steps of: fetching an FAT chain corresponding to a file; determining whether at least an index entry contained in the FAT chain is valid; and modifying one of the at least one index entry to be valid when the modified entry is examined as invalid. Through the recovery method, FAT files, specifically having FAT chain entries which are invalid or inferring file sizes larger than the maximum length representable by the FAT file system, can be efficiently recovered in the Linux system to minimize data loss as well as to prevent a system crash.

This application claims the benefit of People's Republic of China Patent Application Serial No. 201110234885.8, filed Aug. 16, 2011, the subject matter of which is incorporated herein by reference.

### BACKGROUND OF THE INVENTION

1. Field of the Invention

The present disclosure relates in general to the computer technology field, and more particularly to a recovery method and device for Linux operating systems using a FAT file system.

2. Description of the Related Art

A File Allocation Table (FAT) file system is a file system developed and partially patented by Microsoft. The FAT file system was initially implemented for the use of the Microsoft Disk Operating System (MS-DOS). When the FAT file system was first designed, it was given a fairly simple structure considering that computer performance at that time was rather limited and most all operating systems of personal computers could support the use of the FAT file system. Such minimal complexity features of the FAT file system makes the FAT file system ideal for software and memory card file systems, and the FAT file system is also suitable for data exchange between different operating systems.

In a current embedded system, the number of applications relying on externally connected storage devices is ever-increasing. Again, the FAT file system, offering advantages of having simple structure and high performance, is prevalent in Linux embedded applications.

The FAT file system includes a file allocation table (FAT) which records storage addresses of hardware data. Each of the files in the FAT file system has a set of corresponding FAT chains. The FAT chains corresponding to the files are utilized for designating a cluster address of one or multiple clusters. In addition, each available cluster in the FAT corresponds to an entry. An “entry value” filled in the entry corresponding to a cluster number indicates whether the cluster in the data region is occupied, idle, or damaged.

An embedded system often adopts a Linux operating system and utilizes a FAT file system (to be referred to as Linux FAT) for recording file addresses. Under a Linux FAT environment, during read/write operations of files, the FAT file system is more likely damaged by an accidental power-off or an unexpected removal of an associated hot-swapping device. However, current techniques are incapable of recovering such damaged files. In the event that the damaged files are further operated, access failures to the damaged files may be permanent, potentially incurring the catastrophic consequence of an entire system crash.

Although the damaged files may be completely recovered through conventional recovery tools provided in a personal computer system, the recovery method is rather time-consuming and is thus inappropriate for embedded systems.

Therefore, there is a need for a solution providing a quick recovery method for a Linux FAT file system, so as to minimize data loss, as well as to prevent a system crash.

### SUMMARY OF THE INVENTION

The present disclosure is directed to a recovery method and device for a Linux FAT file system, which is capable of automatically recovering FAT file system damages resulted by accidental power-off and unexpected removal of associated hot-swapping devices, so as to minimize user inconveniences and complications caused by the damages to further optimize user experiences.

According to an aspect of the present disclosure, a recovery method for a file system applied to Linux using a File Allocation Table (FAT) file system is provided. The recovery method comprises steps of: fetching a FAT chain corresponding to a file; determining whether at least an index entry contained in the FAT chain is valid in sequence; and modifying the index entry to be valid when it is determined as invalid.

According to another aspect the present disclosure, a recovery device for a file system applied to Linux using an FAT file system is provided. The device comprises: a first retrieving module, for fetching a FAT chain corresponding to a file; an examining module, for determining whether at least one index entry in the FAT chain is valid; and a first modifying module, for modifying the index entry to be valid when it is determined as invalid.

Being distinct from the prior art, according to the embodiments of the present disclosure, validity of the FAT is checked. The FAT is modified to become valid when it is found to be invalid, so that subsequent access to the files can be successfully performed without error or interruption. Further, the present disclosure provides an automatic recovery function for recovering FAT file system damages resulted by accidental power-off and unexpected removal of associated hot-swapping devices, so as to minimize user inconveniences and complications caused by the damages to further optimize user experiences.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart of a recovery method applied to a Linux operating system for recovering data of an FAT file system according to an embodiment of the present disclosure.

FIG. 2 is a schematic diagram of a faulty situation in an FAT chain according to an embodiment of the present disclosure.

FIG. 3 is a schematic diagram of the FAT chain in FIG. 2 being recovered.

FIG. 4 is a schematic diagram of another faulty situation in an FAT chain according to an embodiment of the present disclosure.

FIG. 5 is a schematic diagram of the FAT chain in FIG. 4 being recovered.

FIG. 6 is a schematic diagram of another faulty situation in an FAT chain according to an embodiment of the present disclosure.

FIG. 7 is a schematic diagram of the FAT chain in FIG. 6 being recovered.

FIG. 8 is a flowchart of a recovery method for the FAT chain in FIG. 6 according to an embodiment of the present disclosure.

FIG. 9 is a schematic diagram of a logic structure of a recovery device for a Linux FAT file system according to an embodiment of the present disclosure.

FIG. 10 is a schematic diagram of another logic structure of a recovery device for a Linux FAT file system according to an embodiment of the present disclosure.

### DETAILED DESCRIPTION OF THE INVENTION

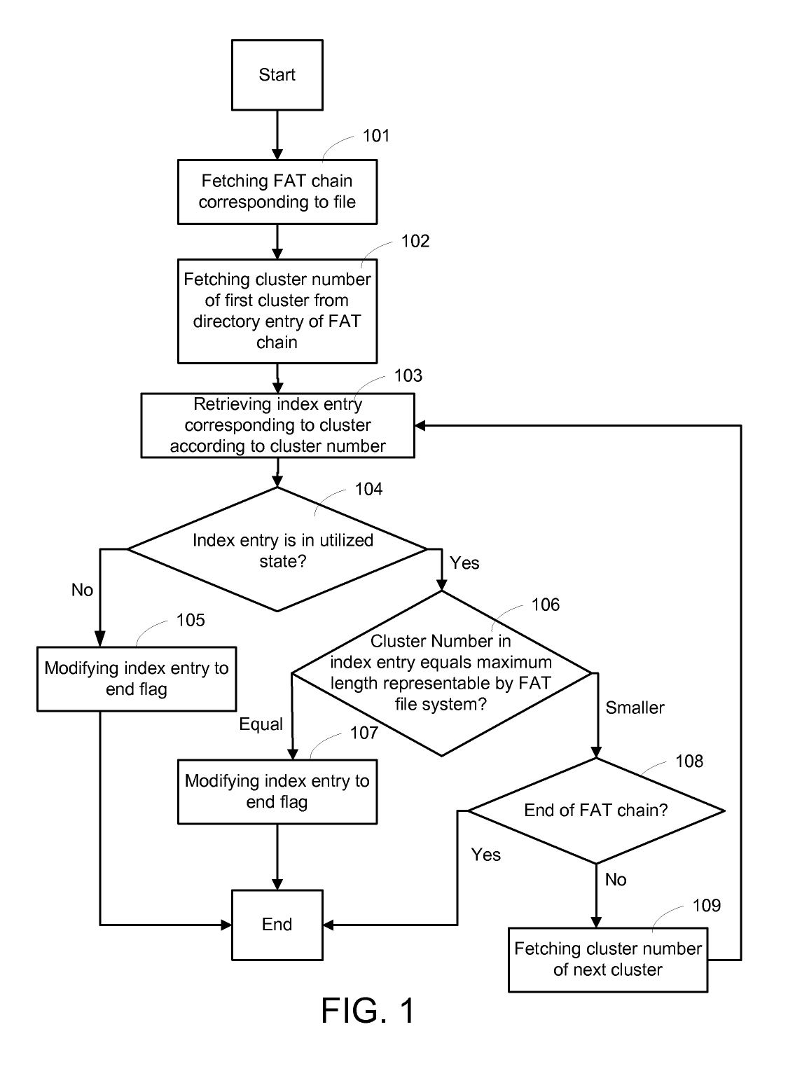

FIG. 1 shows a flowchart of a recovery method applied to a Linux operating system for recovering data of a FAT file system according to an embodiment of the present disclosure.

In Step 101, a FAT chain corresponding to a file is fetched. The FAT file system comprises a FAT, and the FAT records storage addresses of hardware data. Each file has a FAT chain that designates a cluster address for storing one or multiple clusters. Hence, in order to access a file after obtaining a file name, the FAT chain corresponding to the file is first fetched from the FAT.

In Step 102, from a directory entry of the FAT chain, a cluster number of a first cluster is fetched. That is, after fetching the FAT chain corresponding to the file, the cluster number of the first cluster is fetched from the directory entry of the FAT chain.

In Step 103, an index entry corresponding to the cluster is obtained according to the cluster number of the first cluster. Each cluster has a sole corresponding cluster number, and each cluster has a sole index entry for recording whether the cluster is occupied, idle, or damaged. Therefore, the index entry corresponding to the cluster may be obtained after fetching the cluster number of the cluster.

In Step 104, it is determined whether the index entry is in a utilized state. The index entry is used for recording the state of the corresponding cluster, such as whether the corresponding cluster is occupied, idle, or damaged. After obtaining the index entry of the corresponding cluster according to the cluster number, it is determined whether the entry is utilized according to data in the index entry.

When the index entry contains a cluster number, it means that the file needs to be further stored to other clusters, and so that cluster number recorded in the index entry represents the cluster number of a next cluster. Hence, it is determined that the index entry is in a utilized state and is also valid.

When the index entry indicates an idle state, e.g., when the state is FREE(0), it means the cluster number of the cluster is written to the directory entry of the FAT chain while the index entry corresponding to the cluster is not yet updated, and so it is determined that the index entry is invalid.

In Step 105, the index entry is modified to an end flag. That is, when it is determined in Step 104 that the index entry is in an idle state, e.g., the index entry is FREE(0), the index entry is modified to an end flag and the process ends. For example, the value of the end flag is the end-of-file marker (EOF) (0x0FFFFFFF).

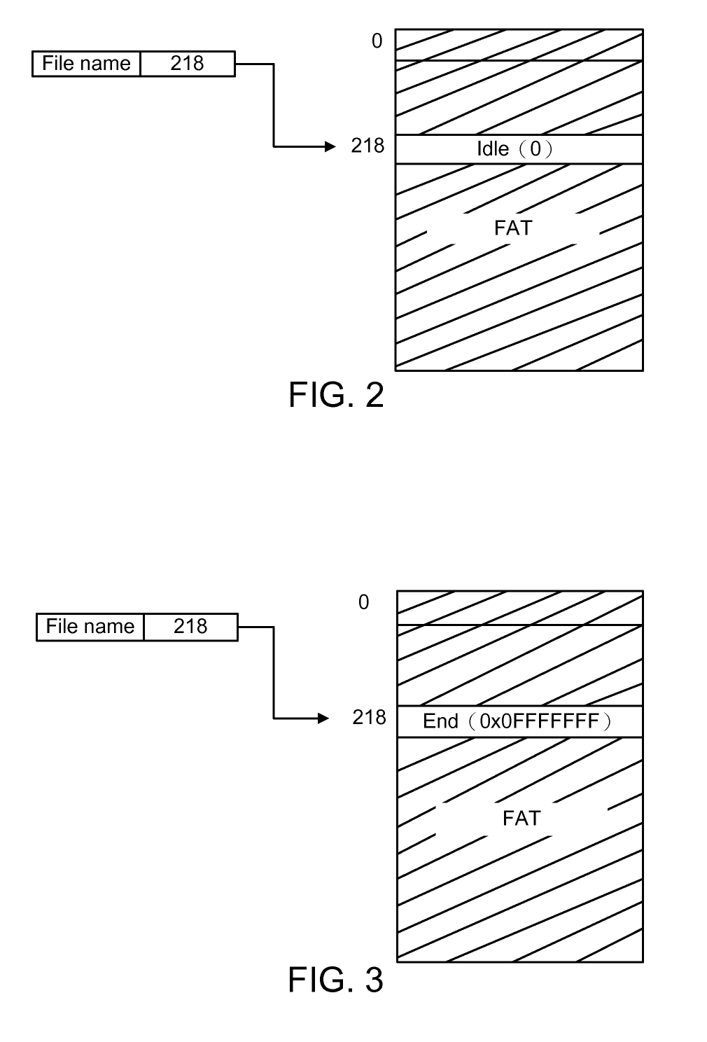

FIG. 2 shows a schematic diagram of a faulty situation in a FAT chain according to an embodiment of the present disclosure; FIG. 3 shows a schematic diagram of the FAT chain in FIG. 2 being recovered.

Referring to FIG. 2, a cluster number of a first cluster fetched from a directory entry of a FAT chain is 218. According to the cluster number 218 of the first cluster, an index entry corresponding to the cluster is searched. The index entry corresponding to the cluster number 218 of the first cluster is FREE(0), i.e., the index entry is idle.

With FIG. 2, it is illustrated that, when a file or a folder is designated with the first cluster and the cluster number of the first cluster is written into the directory entry, the index entry corresponding to the cluster in the FAT is however not yet updated, and still indicated as idle. Thus, when accessing the file or the folder, data cannot be accessed and so an access failure is resulted to even further cause a system crash.

In reaction to the above situation, the index entry corresponding to the cluster in the FAT may be modified to EOF (0x0FFFFFFF) as shown in FIG. 3 to modify the cluster number of the first cluster to an end flag. Such an approach is to prevent a file access failure and a system crash.

In Step 106, it is determined whether the cluster number in the index entry equals a maximum length representable by the FAT file system. Further, when it is determined in Step 104 that the index entry is utilized, the cluster number in the index entry and the maximum length representable by the FAT file system are obtained. It is then determined whether the cluster number in the index entry equals to the maximum length representable by the FAT file system.

The cluster number includes a logical cluster number (LCN) and a virtual cluster number (VCN) that corresponds to each other.

The logic cluster number is a simple number respectively assigned to all clusters from beginning to end of an entire volume; the virtual cluster number is a number assigned to clusters from beginning to end of a specific file.

Since each cluster has a fixed size, a size of the file may be inferred from the first cluster to a current cluster according to the virtual cluster number. Due to the correspondence between the logic cluster number and the virtual cluster number, a size of a specific file may also be obtained with a known logic cluster number.

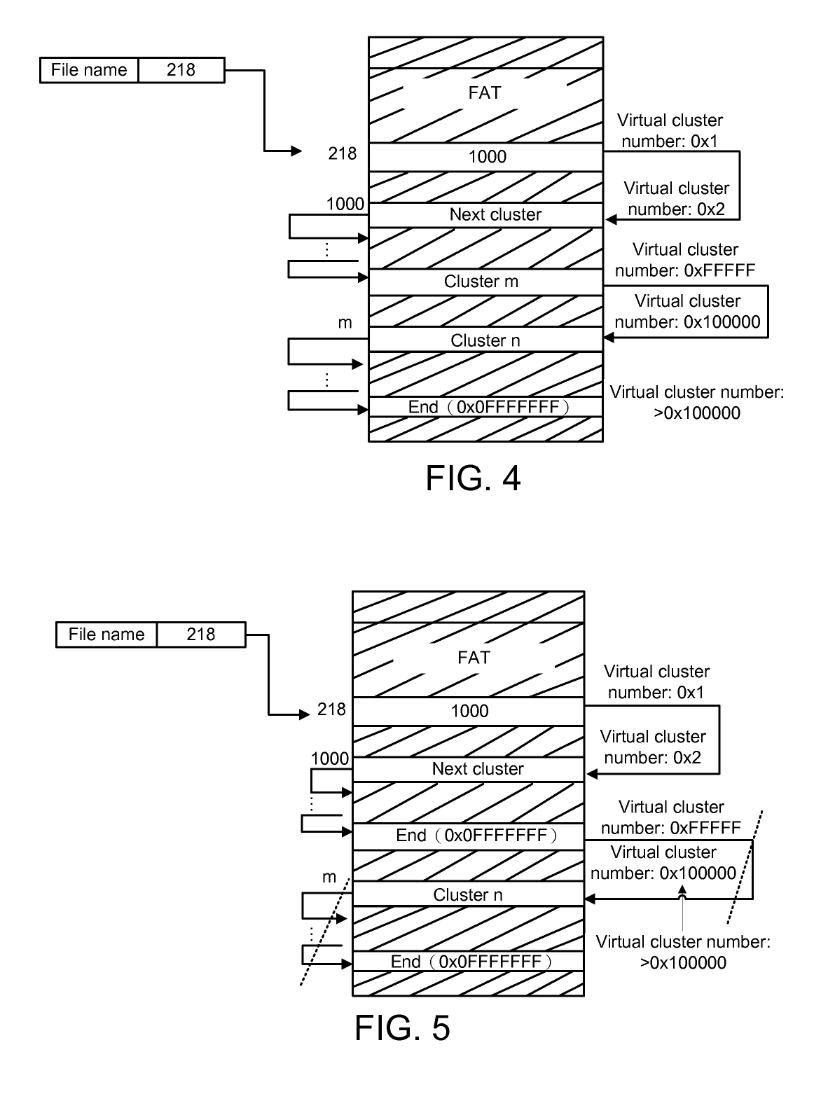

In Step 107, when the cluster number in the index entry equals the maximum length representable by the FAT file system, the index entry is modified to an end flag. When it is determined in Step 106 that the virtual cluster number in the index entry equals the maximum length representable by the FAT file system, the content of the index entry is modified to an end flag and the process ends. Detailed operations of the above shall be given shortly with reference to FIGS. 4 and 5.

For example, FAT32 is capable of storing a 4 gigabyte (4 GB) file maximum, and a corresponding virtual cluster number is 0x100000. Therefore, for the FAT 32 file system, the value 0x100000 serves as a comparison basis in Step 106.

In FIG. 4, the logic cluster number of the first cluster in the directory entry is 218, and the virtual cluster number corresponding to the logic cluster number is 0x1. The index entry in the cluster 218 records that the logic cluster number of the next cluster is 1000, and the virtual cluster number corresponding to the logic cluster number 1000 is 0x2. Hence, a FAT chain is formed from a cluster following a previous cluster.

The virtual cluster number corresponding to a cluster m is 0x10000, which is the maximum length of the FAT32. However, it is indicated by the index entry of the cluster m that the cluster m is not a last cluster and a next cluster n is yet present. That is to say, the content of the virtual cluster number and the index entry is contradictory and may thus lead to faulty file access.

In other words, although the FAT chain indicates that the file length is greater than 4 GB, the physical data region is nevertheless capable of storing only 4 GB data maximum. Therefore, data cannot be found when accessing the file, leading to an access failure. Consequently, the file is possibly set to read-only due to the abnormality and damages detected, and may even incur a resulting system crash.

In reaction to the above situation, the index entry of the last cluster may be set to EOF (0x0FFFFFFF), i.e., an end flag. The last flag means that, in all the entries of the FAT chain, the virtual cluster number of the next cluster equals the cluster having the maximum length representable by the FAT file system.

As shown in FIG. 5, partial data may be lost by the approach, and the remaining data is somewhat flawed compared to intact data or data that is fully recovered. However, for a recovery performed based on no damage statistics, rather time-consuming scanning and analysis are required for the entire FAT and all the entries.

More particularly, when a capacity of partitions of a FAT is enlarged, the time consumed is geometrically increased, and the lengthy recovery process is rather inappropriate for embedded systems that require higher real-time standards. Therefore, the recovery method according to the embodiment is simple and effective. Such approach reinforces the stability of the FAT file system and enhances user experiences.

In Step 108, it is determined whether an end of the FAT chain is reached. When the end of the FAT chain is reached as determining whether the end of FAT chain is reached, the index entry is recorded as EOF (0x0FFFFFFF) and the process ends. Conversely, when end of FAT chain is not yet reached, Step 109 is performed.

In Step 109, the cluster number of the next cluster is fetched. When it is determined that the end of the file (i.e., end of the FAT chain) is not yet reached in Step 108, the cluster number of the next cluster is fetched until the end of the FAT chain is reached, and the process continues with the step of retrieving the corresponding index entry for the new cluster according to the cluster number (Step 103).

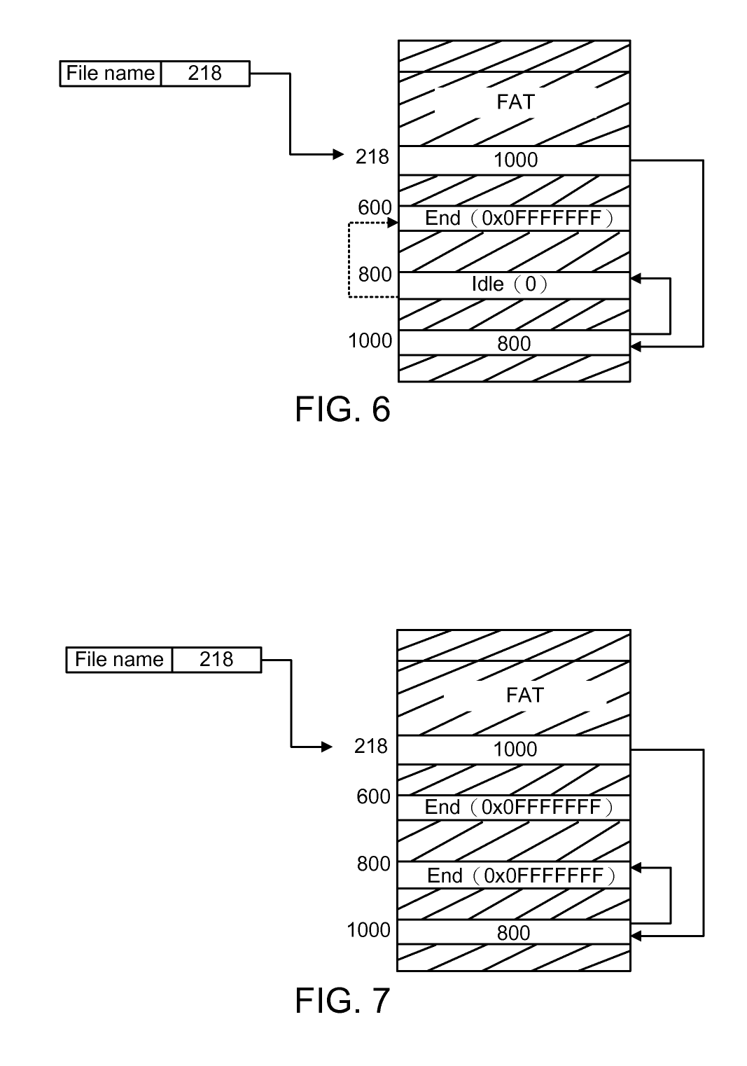

FIG. 6 shows another faulty situation (a disconnection) of a FAT chain according to an embodiment of the present disclosure. FIG. 7 shows a recovery method for recovering the FAT chain in FIG. 6 according to a preferred embodiment of the present disclosure.

As shown in FIG. 6, a cluster number 218 of a first cluster is fetched from a directory entry of a FAT chain. The index entry of the cluster 218 records that the cluster number of a next cluster is 1000. The cluster 1000 is identified according to the cluster number 1000, and the index entry in the cluster 1000 records that the cluster number of the next cluster is 800. Since the index entry in the cluster 800 is not the end flag EOF (0x0FFFFFFF), it means that the FAT chain corresponding to the file is not yet finished. However, the index entry in the cluster 800 is FREE(0), i.e., the index entry indicates the cluster is idle.

When the end flag EOF (0x0FFFFFFF) is not yet reached, an occurrence of FREE(0) in the FAT chain means that the FAT chain is disconnected. Thus, when accessing the file or the folder, data cannot be accessed and so an access failure is resulted to even further cause a system crash. In reaction to the above situation, the entry corresponding to the cluster in the FAT may be modified to EOF (0x0FFFFFFF), i.e., to an end flag.

As shown in FIG. 7, although the above approach may lead to partial data loss, a severe error such as complete data access failure or a system crash is unlikely to occur.

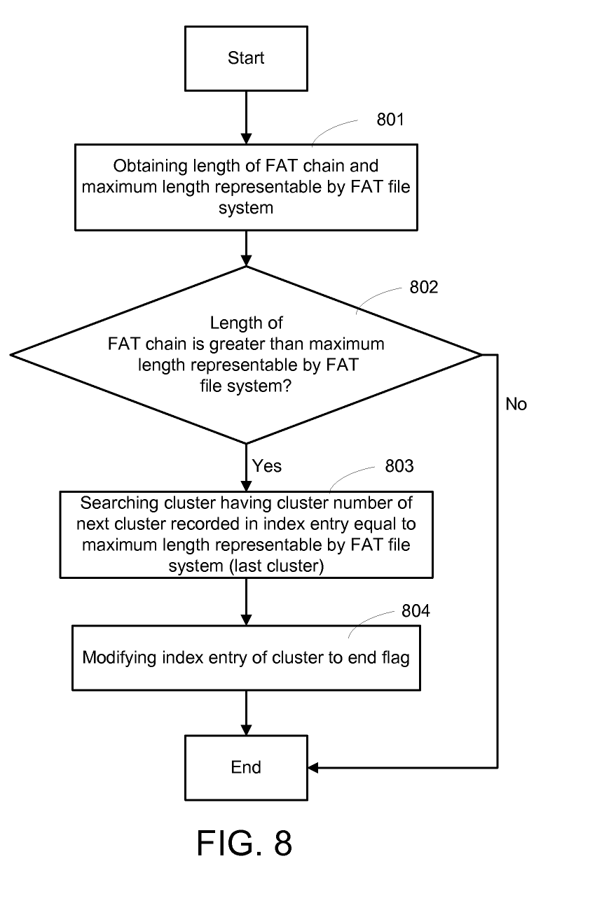

With reference FIG. 8, detailed steps for recovering the file system under the condition that the length of the FAT chain exceeds the maximum length representable by the FAT file system.

In Step 801, the length of the FAT chain and the maximum length representable by the FAT file system are obtained.

In Step 802, it is determined whether the length of the FAT chain is greater than the maximum length representable by the FAT file system. When the length of the FAT chain is shorter than the maximum length representable by the FAT file system, the process ends. In contrast, the process performs Step 803 when the length of the FAT chain is greater than the maximum length representable by the FAT file system.

The cluster number of the next cluster recorded in the index entry in the last cluster represents the cluster having the maximum length representable by the FAT file system. In Step 803, when the length of the FAT chain is greater than the maximum length representable by the FAT file system, the last cluster is searched. That is, the last cluster is searched from the first cluster of the FAT chain.

In Step 804, the index entry of the cluster is modified to an end flag. When the last cluster is found in the FAT chain in Step 803, the index entry of the last cluster is modified to an end flag, and the process ends.

According to the operations of this embodiment, partial data may be lost by the approach, and the remaining data is somewhat flawed compared to intact data or data that is fully recovered. However, for a recovery performed based on no damage statistics, rather time-consuming scanning and analysis are required for the entire FAT and all the entries.

More particularly, when a capacity of partitions of a FAT is enlarged, the time consumed is geometrically increased, and the lengthy recovery process is rather inappropriate for embedded systems that require higher real-time standards. Therefore, the recovery method according to the embodiment is simple and effective. Such approach reinforces the stability of the FAT file system and enhancing user experiences.

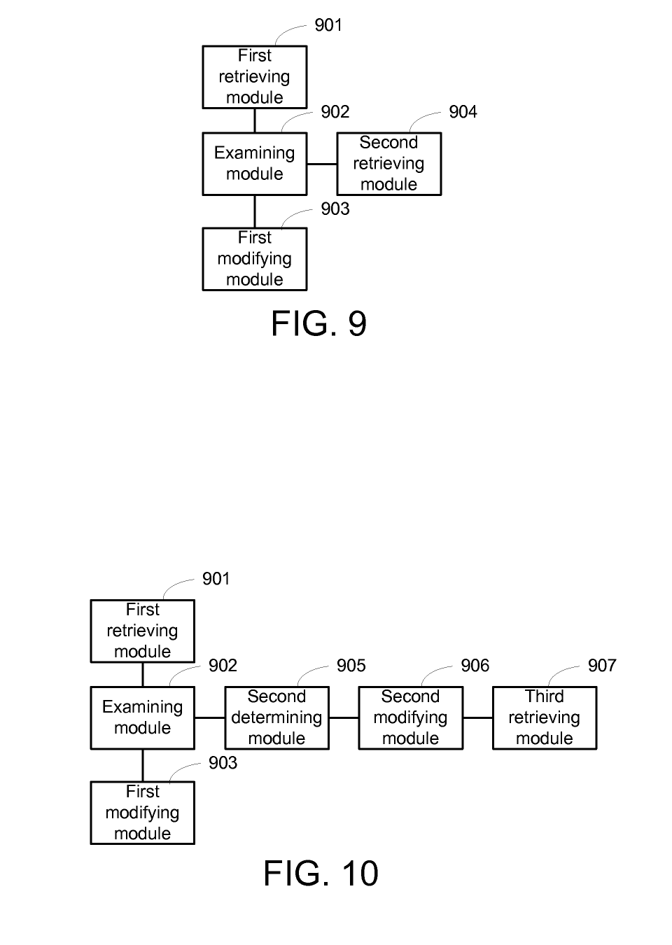

FIG. 9 shows a schematic diagram of a logic structure of a recovery device providing a recovery function for a Linux FAT file system according to a preferred embodiment of the present invention. The recovery device for a Linux FAT file system comprises a first retrieving module 901, an examining module 902, and a first modifying module 903.

With reference to the description above, the first retrieving module 901 is for fetching the FAT chain corresponding to a file. The examining module 902 sequentially determines whether the index entry in the FAT chain fetched by the first retrieving module 901 is valid. When the examining module 902 determines that the entry is invalid, the modifying module 903 modifies the index entry to be valid.

The examining module 902 comprises a retrieving unit (not shown), a second retrieving unit (not shown), and a first determining unit (not shown). The first retrieving unit fetches the cluster number of the first cluster from the directory entry in the FAT chain fetched by the first retrieving module 901. According to the cluster number fetched by the first retrieving unit, the second retrieving unit retrieves the index entry corresponding to the cluster. The first determining unit determines whether the index entry retrieved by the second retrieving unit is in a utilized state.

When the index entry retrieved by the second retrieving unit indicates the cluster number of the next cluster, the first determining unit determines that the index entry is valid. When the index entry indicates an idle state, i.e., FREE(0), the first determining unit determines that the index entry is invalid.

The recovery device for a Linux FAT file system in this embodiment further comprises a second retrieving module 904. The second retrieving module 904 is for fetching the cluster number of the next cluster when the first determining unit determines that the index entry is in a utilized state.

FIG. 10 shows a schematic diagram of a logic structure of a recovery device for a Linux FAT file system according to another embodiment of the present invention. In this embodiment, the recovery device further comprises a second determining module 905, a second modifying module 906, and a third retrieving module 907.

When the first determining unit determines that the index entry is in a utilized state, the second determining module 905 determines whether the cluster number in the index entry equals the maximum length representable by the FAT file system.

When the second determining module 905 determines that the cluster number recorded in the index entry equals the maximum length representable by the FAT file system, the second modifying module 906 modifies the content of the index entry. That is, the second modifying module 906 modifies the index entry to an end point flag.

The third retrieving module 907 is for fetching the cluster number of the next cluster. That is, when the second determining module 905 determines that the cluster number of the cluster is smaller than the maximum length representable by the FAT file system, the third retrieving module 907 fetches the cluster number of the next cluster.

In another embodiment, the recovery device for a Linux FAT file system further comprises a third modifying module (not shown). When the length of the FAT chain is greater than the maximum length representable by the FAT file system, the third modifying module modifies the entry in the last cluster to an end flag. The last cluster represents the cluster having the maximum length representable by the entry for the FAT file system.

Further, the third modifying module comprises a retrieving unit (not shown), a determining unit (not shown) and a modifying unit (not shown). Functions of the units are described below.

The retrieving unit is for obtaining the length of the FAT chain and the maximum length representable by the FAT file system. The determining unit is for determining whether the length of the FAT chain fetched by the retrieving unit is greater than the maximum length representable by the FAT file system.

When the determining unit determines that the length of the FAT file is greater than the maximum length representable by the FAT file system, the modifying unit searches the last cluster. The cluster number of the next cluster of the last cluster is the cluster having the maximum length representable by the entry for the FAT file system, and the entry of the last cluster is modified to an end flag.

Therefore, according to the embodiments of the present invention, validity of the FAT is checked. The FAT is modified to valid when it is found invalid, so that subsequent access to the files can be successfully performed. Further, the present invention provides an automatic recovery function for recovering FAT file system damages resulted by accidental power-off and unexpected removal of associated hot-swapping devices, so as to minimize user inconveniences and complications caused by the damages to optimize user experiences.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A recovery method for a file system, applied to a File Allocation Table (FAT) file system, the method comprising:
fetching a FAT chain corresponding to a file;
sequentially determining whether at least one index entry in the FAT chain is valid; and
modifying the index entry to be valid when it is determined as invalid.

2. The recovery method according to claim 1, wherein the step of sequentially examining whether the at least one index entry in the FAT chain is valid comprises:
fetching a cluster number corresponding to a first cluster from a directory entry of the FAT chain;
retrieving an index entry of a corresponding cluster according to the cluster number of the first cluster; and
determining whether the index entry is in a utilized state, and when the index entry is in a utilized state, determining the index entry as valid when the entry is a cluster number of a next cluster, or else determining the index entry as invalid when the index entry represents an idle state.

3. The recovery method according to claim 2, wherein the step of sequentially determining whether the at least one index entry in the FAT chain is valid further comprises:
fetching the cluster number of the next cluster until an end of the FAT chain is reached when it is determined that the index entry is in the utilized state.

4. The recovery method according to claim 3, when the index entry is being determined as invalid, the method further comprising:
modifying the index entry to an end flag when the index entry indicates the idle state.

5. The recovery method according to claim 4, wherein the step of sequentially determining whether the at least one index entry in the FAT chain is valid further comprises:
determining whether the cluster number in the index entry equals a maximum length representable by the FAT file system when the at least one index entry is in the utilized state;
modifying the index entry to the end flag when the cluster number in the at least one index entry equals the maximum length representable by the FAT file system; and
fetching the cluster number of the next cluster until the end of the FAT chain is reached when the cluster number in the at least one index entry is smaller than the maximum length representable by the FAT file system.

6. The recovery method according to claim 1, further comprising:
when a length represented by the FAT chain is greater than the maximum length representable by the FAT chain, modifying the index entry of a last cluster to an end flag;
wherein, the last cluster is a cluster with the maximum length representable by the index entry for the FAT file system.

7. The recovery method according to claim 6, wherein when the length represented by the FAT chain is greater than the maximum length of the FAT chain, the step of modifying the index entry of the last cluster to the end flag comprises:
obtaining a length of the FAT chain and the maximum length representable by the FAT file system; and
searching the last cluster when the length of the FAT chain is greater than the maximum length representable by the FAT file system, and modifying the index entry of the last cluster to the end flag.

8. A recovery device for a file system, applied to a Linux FAT file system, the recovery device comprising:
a first retrieving module, for fetching an FAT chain corresponding to a file;
an examining module, for sequentially determining whether at least one index entry in the FAT chain is valid; and
a first modifying module, for modifying the at least one index entry to be valid when the at least one index entry is examined as invalid.

9. The recovery device according to claim 8, wherein the examining module comprises:
a first retrieving unit, for fetching a cluster number of a first cluster from a directory entry in the FAT chain fetched by the first retrieving module;
a second retrieving unit, for retrieving the index entry corresponding to the cluster number of the first cluster; and
a determining unit, for determining whether the index entry is in a utilized state, and determining the index entry as valid when the index entry represents a cluster number of a next cluster or determining the index entry as invalid when the index entry represents an idle state.

10. The recovery device according to claim 9, further comprising:
a second retrieving module, for fetching the cluster number of the next cluster when the index entry is in the utilized state.

11. The recovery device according to claim 10, further comprising:
a second determining module, for determining whether the cluster number in the index entry equals a maximum length representable by the FAT file system;
a second modifying module, for modifying the index entry to an end flag when the cluster number in the index entry equals the maximum length representable by the FAT file system; and
a third retrieving module, for fetching the cluster number of the next cluster when the second determining module determines that the cluster number in the index entry is smaller than the maximum length representable by the FAT file system.

12. The recovery device according to claim 8, further comprising:
a third modifying module, for modifying the index entry of a last cluster to an end flag when a length of the FAT chain is greater than a maximum length representable by the FAT file system;
wherein, the last cluster is the cluster having the maximum length representable by the index entry for the FAT file system.

13. The recovery device according to claim 12, wherein the third modifying module comprises:
a retrieving unit, for obtaining the length of the FAT chain and the maximum length representable by the FAT file system;
a determining unit, for determining whether the length of the FAT chain is greater than the maximum length representable by the FAT file system; and
a modifying unit, for searching the last cluster when the length of the FAT chain is greater than the maximum length representable by the FAT file system, and modifying the index entry of the last cluster to the end flag;
wherein, the last cluster is a cluster recorded in the index entry, and the cluster number of the next cluster of the last cluster is the cluster having the maximum length representable by the index entry for the FAT file system.
